(19) United States
(12) Patent Application Publication
(10) Pub. No.: US 2026/0057688 A1
(43) Pub. Date: Feb. 26, 2026

(54) INFORMATION PROCESSING APPARATUS, INFORMATION PROCESSING METHOD, AND NON-TRANSITORY COMPUTER READABLE MEDIUM

(71) Applicant: NEC Corporation, Tokyo (JP)

(72) Inventor: Manabu NAKANOYA, Tokyo (JP)

(73) Assignee: NEC Corporation, Tokyo (JP)

(21) Appl. No.: 19/288,259

(22) Filed: Aug. 1, 2025

(30) Foreign Application Priority Data
Aug. 21, 2024 (JP) 2024-139759

(51) Int. Cl. G06V 30/14; G06V 30/148; G06V 30/19

(52) U.S. Cl. CPC G06V 30/1444; G06V 30/153; G06V 30/19127

(57) ABSTRACT

An information processing device includes a division unit, a recognition unit, an index assignment unit, an input data generation unit, and an output data acquisition unit. The division unit divides a target image including a target object and multiple character strings into multiple small areas. The recognition unit recognizes the character strings by performing character recognition processing using the target image, and recognizes positions of the character strings. The index assignment unit assigns, to each small area, an index associated with a relative positional relationship of the small areas. The input data generation unit generates input data including an input feature in which a positional feature obtained by encoding the index is added to a word feature extracted from each character string. The output data acquisition unit obtains output data obtained by inputting the input data to a language model.

This application is based upon and claims the benefit of priority from Japanese patent application No. 2024-139759, filed on Aug. 21, 2024, the disclosure of which is incorporated herein in its entirety by reference.

### TECHNICAL FIELD

The present invention relates to an information processing apparatus, an information processing method, and a non-transitory computer readable medium.

### BACKGROUND ART

For example, JP 2019-49943 A discloses an image processing device that extracts information from an image such as a flier image. The image processing device includes a small area extraction unit, a character/target object area extraction unit, a character recognition unit, and an object recognition unit.

The small area extraction unit disclosed in JP 2019-49943 A extracts an image of a small area from the entire flier image. In JP 2019-49943 A, the image of the small area indicates an area surrounded by a boundary line in the image, and is an image in which an image of an object as a target object (which will be referred to as a target object image hereinafter) and a character string image are drawn. The character/target object area extraction unit disclosed in JP 2019-49943 A extracts an image in which a character string is drawn from the image of the small area extracted by the small area extraction unit. The character/target object area extraction unit further extracts the target object image from the small area extracted by the small area extraction unit.

The character recognition unit disclosed in JP 2019-49943 A recognizes a character from each image based on images of characters constituting the character string included in the region of the character string image extracted by the character/target object area extraction unit. The object recognition unit disclosed in JP 2019-49943 A recognizes an object based on the target object image included in the image of the small area extracted by the small area extraction unit. In JP 2019-49943 A, “recognizing an object” indicates determining a name of a target object included in a target object image.

According to the disclosure of JP 2019-49943 A, character information included in the image may be compared with the name of the target object, and a product name recognized from the image of the product shown in the flier image is obtained to enable verification of information extracted through character recognition, which enable more accurate information extraction.

### SUMMARY

According to the technique disclosed in JP 2019-49943 A, even if the target object may be associated with a character string included in an image of the same small area, it is difficult to associate the target object with a character string included in an image of a different small area. Thus, according to the technique disclosed in JP 2019-49943 A, it is difficult to accurately identify a large number of character strings relevant to the target object from a target image including the target object and a plurality of character strings.

An object of the present disclosure is to accurately identify a larger number of character strings relevant to a target object from a target image.

An information processing device according to an aspect of the present disclosure includes
a division means for dividing a target image including a target object and a plurality of character strings into a plurality of small areas,
a recognition means for recognizing the plurality of character strings by performing character recognition processing using the target image and recognizing a position of the plurality of character strings in the target image,
an index assignment means for assigning an index associated with a relative positional relationship of the plurality of small areas in the target image to each of the plurality of small areas,
an input data generation means for generating input data including an input feature in which, to a word feature extracted from each of the plurality of character strings, a positional feature obtained by encoding the index of the small area relevant to the position of the character string is added, and
an output data acquisition means for obtaining output data obtained by inputting the input data to a language model.

An information processing method according to an aspect of the present disclosure causes one or more computers to perform a process including
dividing a target image including a target object and a plurality of character strings into a plurality of small areas,
recognizing the plurality of character strings by performing character recognition processing using the target image and recognizing a position of the plurality of character strings in the target image,
assigning an index associated with a relative positional relationship of the plurality of small areas in the target image to each of the plurality of small areas,
generating input data including an input feature in which, to a word feature extracted from each of the plurality of character strings, a positional feature obtained by encoding the index of the small area relevant to the position of the character string is added, and
obtaining output data obtained by inputting the input data to a language model.

A program according to an aspect of the present disclosure causes one or more computers to perform a process including
dividing a target image including a target object and a plurality of character strings into a plurality of small areas,
recognizing the plurality of character strings by performing character recognition processing using the target image and recognizing a position of the plurality of character strings in the target image,
assigning an index associated with a relative positional relationship of the plurality of small areas in the target image to each of the plurality of small areas,
generating input data including an input feature in which, to a word feature extracted from each of the plurality of character strings, a positional feature obtained by encoding the index of the small area relevant to the position of the character string is added, and
obtaining output data obtained by inputting the input data to a language model.

According to an example of the present disclosure, a larger number of character strings relevant to a target object may be accurately identified from a target image.

### BRIEF DESCRIPTION OF THE DRAWINGS

FIG. 1 is a block diagram illustrating an outline of a configuration of a first information processing device according to the present disclosure;

FIG. 2 is a flowchart illustrating an outline of a processing operation of the first information processing device according to the present disclosure;

FIG. 3 is a block diagram illustrating a detailed example of the configuration of the first information processing device according to the present disclosure;

FIG. 4 is a flowchart illustrating a detailed example of the processing operation of the first information processing device according to the present disclosure;

FIG. 5 is a block diagram illustrating an exemplary configuration of a first input data generation unit according to the present disclosure;

FIG. 6 is a flowchart illustrating an exemplary processing operation of the first input data generation unit according to the present disclosure;

FIG. 7 is a diagram illustrating an exemplary target image according to the present disclosure;

FIG. 8 is a diagram illustrating a first example regarding a method of dividing the target image into a plurality of small areas according to the present disclosure;

FIG. 9 is a diagram illustrating an example of indexes assigned to the plurality of individual small areas obtained by dividing the target image according to the present disclosure;

FIG. 10 is a diagram illustrating an exemplary configuration of input data according to the present disclosure;

FIG. 11 is a diagram illustrating an exemplary physical configuration of the first information processing device according to the present disclosure;

FIG. 12 is a diagram illustrating a second example regarding the method of dividing the target image into the plurality of small areas according to the present disclosure; and

FIG. 13 is a diagram illustrating a third example regarding the method of dividing the target image into the plurality of small areas according to the present disclosure.

### EXAMPLE EMBODIMENT

Hereinafter, in the present disclosure, the drawings are associated with one or more example embodiments. In all the drawings, similar components are denoted by similar reference signs, and descriptions thereof will be omitted as appropriate.

### First Example Embodiment

### Overview

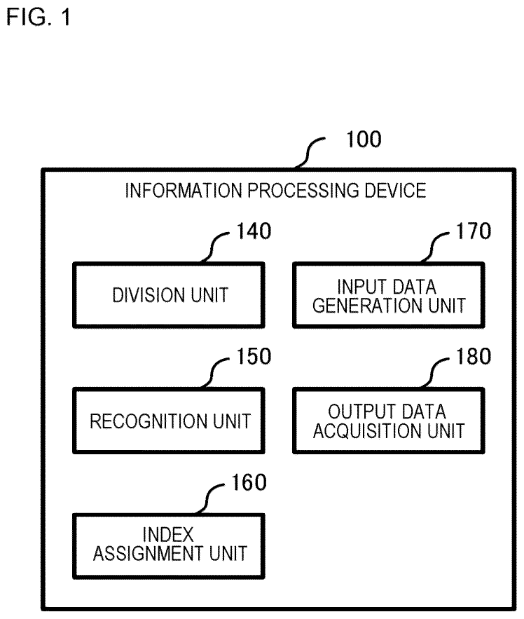

As illustrated in FIG. 1, a first information processing device 100 includes a division unit 140, a recognition unit 150, an index assignment unit 160, an input data generation unit 170, and an output data acquisition unit 180.

The division unit 140 divides a target image including a target object and a plurality of character strings into a plurality of small areas.

The recognition unit 150 performs character recognition processing using the target image, thereby recognizing the plurality of character strings and also recognizing positions of the plurality of character strings in the target image.

The index assignment unit 160 assigns, to each of the plurality of small areas, an index associated with a relative positional relationship of the plurality of small areas in the target image.

The input data generation unit 170 generates input data including an input feature in which a positional feature obtained by encoding the index of the small area relevant to the position of the character string is added to a word feature extracted from each of the plurality of character strings.

The output data acquisition unit 180 obtains output data obtained by inputting the input data to a language model.

According to the information processing device 100, with respect to the target object and the plurality of character strings included in the periphery thereof in the target image, the output data processed by the language model in consideration of the relative positional relationship of the plurality of character strings may be obtained. With such output data being used, a character string relevant to the target object may be identified not only from a character string indicated by the target object but also from a wide range of character strings included in a region other than the target object in the target image. Thus, a larger number of character strings relevant to the target object may be accurately identified from the target image.

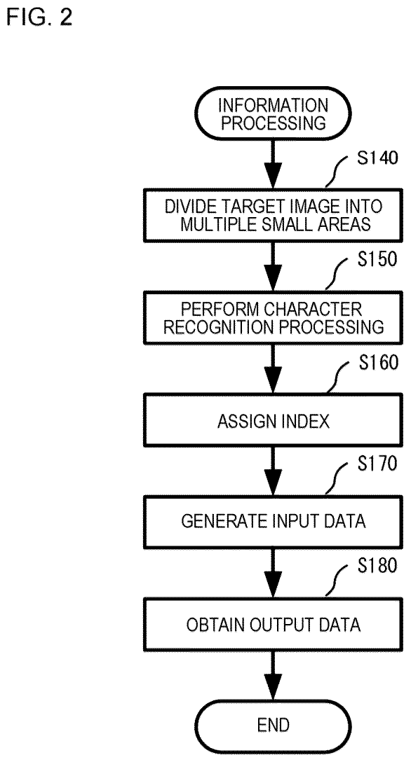

The first information processing device 100 performs first information processing as illustrated in a flowchart of FIG. 2.

The division unit 140 divides a target image including a target object and a plurality of character strings into a plurality of small areas (step S140).

The recognition unit 150 performs character recognition processing using the target image, thereby recognizing the plurality of character strings and also recognizing positions of the plurality of character strings in the target image (step S150).

The index assignment unit 160 assigns, to each of the plurality of small areas, an index associated with a relative positional relationship of the plurality of small areas in the target image (step S160).

The input data generation unit 170 generates input data including an input feature in which a positional feature obtained by encoding the index of the small area relevant to the position of the character string is added to a word feature extracted from each of the plurality of character strings (step S170).

The output data acquisition unit 180 obtains output data obtained by inputting the input data to a language model (step S180).

According to this information processing method, with respect to the target object and the plurality of character strings included in the periphery thereof in the target image, the output data processed by the language model in consideration of the relative positional relationship of the plurality of character strings may be obtained. With such output data being used, a character string relevant to the target object may be identified not only from a character string indicated by the target object but also from a wide range of character strings included in a region other than the target object in the target image. Thus, a larger number of character strings relevant to the target object may be accurately identified from the target image.

Hereinafter, a detailed example of the first information processing device 100 will be described.

### Detailed Example

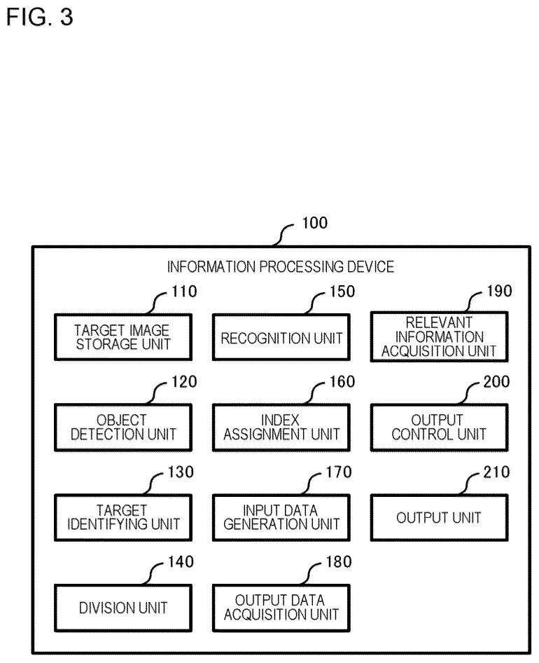

As illustrated in FIG. 3, for example, the first information processing device 100 according to the present disclosure includes a target image storage unit 110, an object detection unit 120, a target identifying means 130, a division unit 140, a recognition unit 150, an index assignment unit 160, an input data generation unit 170, an output data acquisition unit 180, a relevant information acquisition unit 190, an output control unit 200, and an output unit 210.

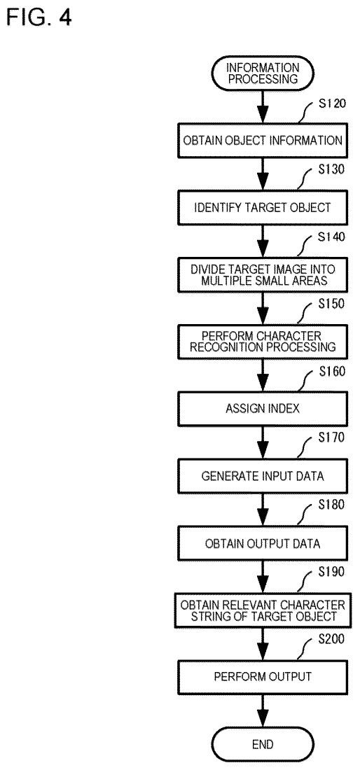

The first information processing device 100 performs the first information processing as illustrated in FIG. 4, for example. For example, the first information processing starts when, for example, a target image to be processed is specified in accordance with a user instruction from among target images stored in the target image storage unit 110 to be described in detail later. The trigger for starting the first information processing is not limited to that exemplified here.

The target image storage unit 110 stores a target image. The target image is an image including at least one object and a plurality of character strings.

The object detection unit 120 obtains object information including a position of the object detected from the target image (step S120).

The target identifying means 130 identifies a target object, which is an object to be processed, from among the detected objects (step S130).

The division unit 140 divides the target image into a plurality of small areas (step S140).

The recognition unit 150 performs character recognition processing using the target image (step S150). The recognition unit 150 recognizes the plurality of character strings included in the target image, and also recognizes positions of the plurality of character strings in the target image.

The index assignment unit 160 assigns, to each of the plurality of small areas, an index associated with a relative positional relationship of the plurality of small areas in the target image (step S160).

The input data generation unit 170 generates input data including an input feature in which a positional feature obtained by encoding the index of the small area relevant to the position of the character string is added to a word feature extracted from each of the plurality of character strings (step S170).

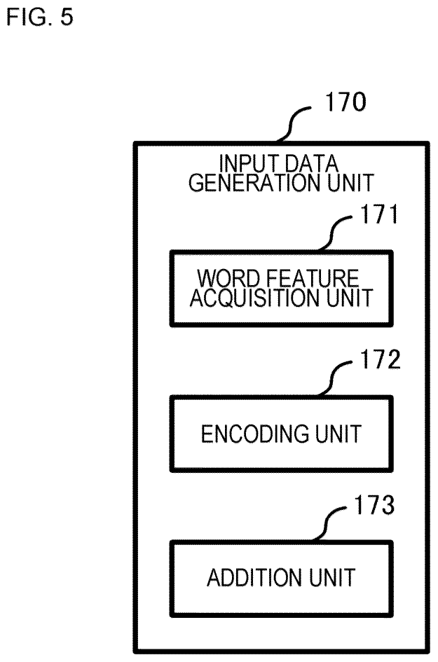

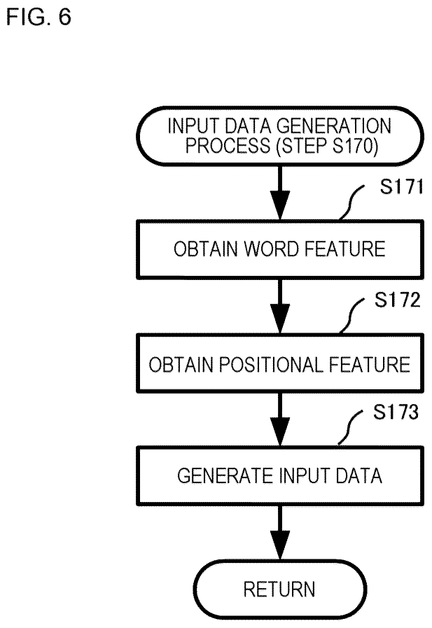

As illustrated in FIG. 5, for example, the input data generation unit 170 includes a word feature acquisition unit 171, an encoding unit 172, and an addition unit 173. Then, the input data generation unit 170 performs an input data generation process (step S170) as illustrated in FIG. 6, for example.

The word feature acquisition unit 171 obtains a plurality of word features obtained by inputting the plurality of individual character strings to a word feature extraction model (step S171).

The encoding unit 172 obtains the positional feature obtained by encoding the index assigned to each of the plurality of small areas (step S172).

The addition unit 173 generates input data including a plurality of input features obtained by adding the positional feature of the relevant small area to each of the plurality of word features (step S173).

FIGS. 3 and 4 will be referred to again.

The output data acquisition unit 180 obtains, for example, output data obtained by inputting the input feature to a language model as a token (step S180).

The relevant information acquisition unit 190 obtains a relevant character string of the target object obtained by inputting information for identifying the target object and the output data to a relevant character string extraction model (step S190). The relevant character string extraction model is, for example, a machine learning model obtained through training for extracting, from a plurality of character strings included in an image, a relevant character string relevant to an object included in the image.

The output control unit 200 causes the output unit 210 to output object-related information (step S200).

Hereinafter, a more detailed example of the processing to be executed by the functional components 110 to 210 included in the first information processing device 100 will be described.

### (Target Image Storage Unit 110)

In the target image storage unit 110, for example, a target image may be an image captured by an imaging device (not illustrated) such as a camera, and the target image storage unit 110 may store the target image captured by the imaging device in advance.

### (Object Detection Unit 120)

The object detection unit 120 obtains, for example, object information including a position of an object detected using an object detection model.

The object detection model is, for example, a machine learning model obtained through training for detecting an object included in an image from the image. The machine learning model is constructed using, for example, a neural network or the like, and the same applies hereinafter.

For example, when an image is input, the object detection model detects an object included in the image, and outputs object information including a position of the object in the image.

The position of the object is, for example, a position of a predetermined point or area with respect to the object. For example, the position of the object may be a position of the center of gravity of the area occupied by the object in the image. For example, the position of the object may be a position of an area indicated by a frame having a predetermined shape (e.g., rectangle) surrounding the object in the image. When the image includes a plurality of objects, the object detection model may output object information including positions of the individual objects. The object information may further include object identification information for identifying the detected one or more objects.

For example, the object detection model may be constructed by supervised learning using training data including images for training and objects and positions thereof included in the images for training. The method of training the object detection model is not limited thereto.

For example, the object detection unit 120 obtains a target image specified by a user from the target image storage unit 110. The method of obtaining the target image by the object detection unit 120 is not limited to the method of obtaining the target image from the target image storage unit 110. For example, the object detection unit 120 may obtain the target image from an imaging device that captures the target image, an external device storing the target image, or the like through a communication network. The communication network is, for example, a network configured by wire, wirelessly, or by a combination thereof, and the same applies hereinafter.

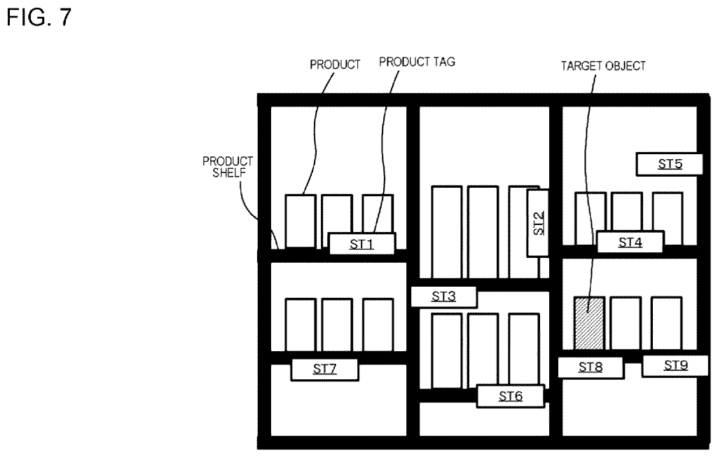

FIG. 7 is a diagram illustrating an example of the target image. The target image exemplified in the drawing includes at least one product, a product shelf on which the product is placed, and a product tag attached to the product shelf. The product is an exemplary object included in the target image. The product tag is a tag on which a character string related to the product is written, and is attached to, for example, the product shelf. The product tag may include, for example, one or more of a product name, a price, a product feature, promotional text, and the like of the product associated therewith. One or a plurality of the product tags may be included in the target image. One or a plurality of the character strings may be written on the product tag. Thus, the target image exemplified in the drawing includes at least one product as an object, and a plurality of character strings ST1 to ST9 written on at least one product tag. The character string only needs to be included in the target image, and is not limited to that written on the product tag. For example, the character string may be written on a package of the product or the like.

For example, the object detection unit 120 may include the object detection model, and may input the obtained target image to the object detection model. The object detection model outputs object information. As a result, the object detection unit 120 may obtain the object information including the position of the object detected from the target image.

The object detection model may be provided in an information processing device (not illustrated) provided outside the first information processing device 100 and connected to each other via a communication network for mutually exchanging information. For example, the first information processing device 100 may transmit the target image to an external information processing device. Then, the external information processing device may input the target image to the object detection model, and may generate the object information as a result thereof to transmit it to the first information processing device 100. This also enables the object detection unit 120 to obtain the object information.

For example, the object information may be information that associates, for each object (e.g., product) included in the target image, the object identification information of the object with the position of the object in the image.

### (Target Identifying Means 130)

The target identifying means 130 identifies the target object from among the detected objects based on, for example, designation by the user. The target object is an object (e.g., product) to be processed. For example, the user may designate the target object from the target image displayed on the output unit 210. For example, the target object may be designated by the area occupied by the target object in the displayed target image being designated. For example, the target image that associates the object with the object identification information may be displayed, and the object identification information may be designated to designate the target object. According to those methods, the user is enabled to designate, as a target object, an object (e.g., product) for which relevant character strings are to be automatically extracted in the target image. In that case, for example, the user may designate, as a target object, a product that may include a character string related to the product in a region other than the package of the product. In FIG. 7, the target object in the products included in the target image is hatched.

The method of designating the target object is not limited to the method exemplified here.

While descriptions will be given using an exemplary case where there is one target object hereinafter, there may be a plurality of target objects. In that case, a process to be described later may be performed for each of the target objects. That is, for example, steps S140 to S190 may be executed for each of the target objects, and results thereof may be collectively output (step S200).

### (Division Unit 140)

The division unit 140 divides the target image into a plurality of small areas in accordance with a predetermined division rule, for example. The division rule may be appropriately set.

For example, the division rule may include a rule of dividing the target image into a plurality of small areas with the position of the target object in the target image as a reference position. That is, the division unit 140 may divide the target image into a plurality of small areas with the position of the target object in the target image as a reference position. As a result, the possibility may be reduced in which the position of the target object is at the boundary of small areas or at a biased position in the vicinity of the boundary. Thus, the position of the target object in the target image may be correctly identified using the small areas.

For example, the division rule may include a rule of dividing the target image into a plurality of small areas in such a way that the area of the small area is smaller as it is closer to the reference position. That is, the plurality of small areas is set to have a smaller area as it is closer to the reference position. As a result, the position of the target object may be more precisely identified using the small areas. Thus, the position of the target object in the target image may be accurately identified using the small areas.

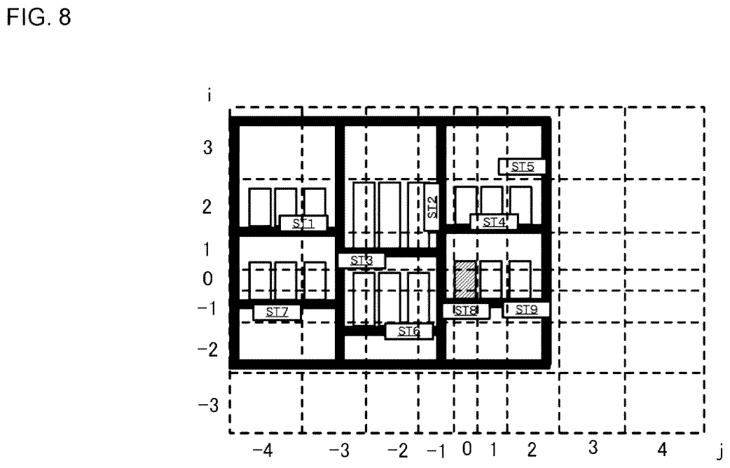

FIG. 8 is a diagram illustrating an exemplary case where the target image is divided into small areas. In the drawing, an example is illustrated in which the target image is divided into rectangular matrix-shaped small areas with boundaries indicated by dotted lines. An example is illustrated in which, with the position of the target object in the target image as a reference position, the area of the small area is smaller as it is closer to the reference position.

The small area of (i, j) exemplified in the drawing may be expressed by the following formulae (1) and (2), for example, where a position in a longitudinal direction is represented by x and a position in a lateral direction is represented by y.

$$\begin{matrix}[ Math . 1 ] & \\ \pm i = [ \frac{log ( \vert x \vert + 1 )}{K N} ] & FORMULA ( 1 )\end{matrix}$$

$$\begin{matrix}[ Math . 2 ] & \\ \pm j = [ \frac{log ( \vert y \vert + 1 )}{K M} ] & FORMULA ( 2 )\end{matrix}$$

In the formula (1), x represents a position of the small area in the longitudinal direction in a coordinate system determined in advance for the target image. An integer indicating a position of the small area in the top-down direction is represented by i. In the example of FIG. 8, i represents an integer that is equal to or more than −3 and equal to or less than 3 with the small area relevant to the target object as 0.

In the formula (2), y represents a position of the small area in the lateral direction in the coordinate system determined in advance for the target image. An integer indicating a position of the small area in the left-right direction is represented by j. In the example of FIG. 8, j represents an integer that is equal to or more than −4 and equal to or less than 4 with the small area relevant to the target object as 0.

N and M represent the number of divisions in the longitudinal and lateral directions. In the example of the drawing, Nis 7, and Mis 9. K represents a constant according to the value range of x and y. A Gauss symbol is represented by | |, and each of |x| and |y| represents a maximum integer value that does not exceed x and y.

The method of dividing the target image into the small areas is not limited to the method exemplified here. For example, the number of the small areas, the shape of the small areas, and the like may be appropriately changed. For example, the small areas may have a predetermined shape (e.g., rectangle, square, etc.) in the same size.

### (Recognition Unit 150)

As described above, the recognition unit 150 performs the character recognition processing using the target image, thereby recognizing the plurality of character strings included in the target image and also recognizing positions of the plurality of character strings in the target image. The position of the character string indicates, for example, a central position of the character string. The position of the character string is not limited to the central position of the character string, and may be a point (e.g., upper left corner, etc.) other than the center determined in advance in relation to the position of the character string.

The character recognition processing is processing for recognizing characters included in the image. For example, a technique used in common optical character recognition (OCR) may be applied to the character recognition processing.

For example, the character recognition processing may be performed using a character recognition model. The character recognition model is, for example, a machine learning model obtained through training for recognizing a plurality of character strings included in the target image and positions of the plurality of character strings in the target image. For example, when an image is input, the character recognition model recognizes a character string included in the image, and outputs recognition result information including a position of the character string in the image.

For example, the object detection model may be constructed by supervised learning using training data including images for training and a plurality of character strings and positions thereof included in the images for training. The method of training the object detection model is not limited thereto.

The recognition unit 150 may include a character recognition model, and may input the target image to the character recognition model. Recognition result information is output from the character recognition model. As a result, the recognition unit 150 may recognize a plurality of character strings included in the target image, and may also recognize, from the target image, positions of the plurality of character strings in the target image.

The character recognition model may be provided in an information processing device (not illustrated) provided outside the first information processing device 100 and connected to each other via a communication network for mutually exchanging information. For example, the first information processing device 100 may transmit the target image to an external information processing device. Then, the external information processing device may input the target image to the character recognition model, and may generate the recognition result information as a result thereof to transmit it to the first information processing device 100. This also enables the recognition unit 150 to recognize the plurality of character strings included in the target image, and also to recognize, from the target image, the positions of the plurality of character strings in the target image.

### (Index Assignment Unit 160)

The index assignment unit 160 assigns an index to each of the plurality of small areas in accordance with, for example, a predetermined assignment rule. The index is a marker for identifying each of the small areas, and may be associated with a relative positional relationship of the plurality of small areas in the target image. While descriptions will be given using an exemplary case where the index is a numerical value hereinafter, the index is not limited to a numerical value, and may be an appropriate combination of a character, symbol, numerical value, and the like.

The assignment rule may be appropriately set.

For example, the assignment rule may include a rule of assigning, to a small area, a number whose value increases by one in predetermined order. The predetermined order may be order according to the arrangement order of the small areas.

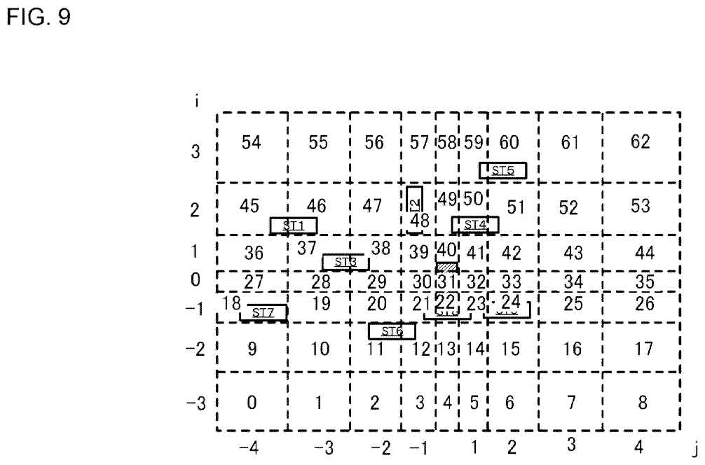

FIG. 9 is a diagram illustrating an example of the indexes assigned to the small areas illustrated in FIG. 8.

The drawing illustrates an example in which a number whose valued increases by one is assigned as an index according to the arrangement order of the small areas that sequentially advance rightward from the upper left small area and then gradually advance downward.

Assuming that the index is IDX, the index IDX may be, for example, a value obtained by a formula of IDX=M×i+j+L. L represents a constant for setting the index IDX to an integer of equal to or more than 0. In the example of FIG. 9, Lis 31, and IDX is an integer of 0 to 62.

In the drawing, in order to illustrate a correspondence relationship among the small area, the target object, and the character strings ST1 to ST9, the target object and the character strings ST1 to ST9 are particularly extracted and illustrated from among the products, product shelves, character strings ST1 to ST9, and the like included in the target image. In the example of the drawing, the target object is illustrated in the small area with IDX of 0. In the example of the drawing, the character strings ST1 to ST9 are illustrated in the small areas of IDX 46, 48, 37, 50, 60, 11, 18, 22, and 24.

The predetermined order is not limited thereto, and may be order according to arrangement order in a predetermined direction (e.g., clockwise, counterclockwise, etc.) in order from the small area close to the reference position. The assignment rule is not limited to those exemplified here.

### (Input Data Generation Unit 170)

For example, as described above, the input data generation unit 170 includes the word feature acquisition unit 171, the encoding unit 172, and the addition unit 173. With this configuration, the input data generation unit 170 generates input data including an input feature in which a positional feature obtained by encoding the index of the small area relevant to the position of the character string is added to a word feature extracted from each of the plurality of character strings.

### Word Feature Acquisition Unit 171

For example, as described above, the word feature acquisition unit 171 obtains a plurality of word features obtained by inputting the plurality of individual character strings to a word feature extraction model.

The word feature extraction model is, for example, a machine learning model obtained through training for extracting a feature of a word (word feature). For example, when one or more words are input, the word feature extraction model outputs a vector representing each of the one or more words as a word feature. As a result, the word may be represented by a point in a vector space. The word feature in this case may be a word feature vector represented by a vector. As such a technique, word2vec may be used, for example.

The word feature extraction model may be, for example, a model that outputs a fixed-length vector representing a word in a case of training, using text for training, a task of predicting a peripheral word from a word included in a sentence, a task of predicting a word included in a sentence from a peripheral word, or the like.

The word feature acquisition unit 171 may include the word feature extraction model, and may input the plurality of character strings recognized from the target image to the word feature extraction model. A word feature (e.g., word feature vector) of each character string is output from the word feature extraction model. As a result, the word feature acquisition unit 171 may obtain a plurality of word features obtained by inputting the plurality of individual character strings to the word feature extraction model.

The word feature extraction model may be provided in an information processing device (not illustrated) provided outside the first information processing device 100 and connected to each other via a communication network for mutually exchanging information. For example, the first information processing device 100 may transmit the plurality of character strings recognized from the target image to an external information processing device. Then, the external information processing device may input the plurality of character strings to the word feature extraction model, and may generate and transmit word features as a result thereof to the first information processing device 100. This also enables the word feature acquisition unit 171 to obtain the plurality of word features obtained by inputting the plurality of individual character strings to the word feature extraction model.

### Encoding Unit 172

For example, as described above, the encoding unit 172 obtains the positional feature obtained by encoding the index assigned to each of the plurality of small areas.

For example, a common technique used in Transformer positional encoding may be applied to the index encoding processing. That is, for example, the encoding unit 172 may perform the encoding processing on the index assigned to each of the plurality of small areas, and may obtain the positional feature representing each index with a vector.

Specifically, for example, it is assumed that a positional feature is represented by a d-dimensional vector. In that case, a value of a 2i component and a value of a 2i+1 component of the positional feature may be expressed as PE (pos, 2i)=sin (pos/10000^{2i/d}) and PE (pos, 2i+1)=cos (pos/10000^{2i/d}), respectively. A position is represented by pos, which may be, for example, an index. The formula for obtaining a positional feature (i.e., method for encoding an index) is not limited thereto.

The encoding processing may be executed in an information processing device (not illustrated) provided outside the first information processing device 100 and connected to each other via a communication network for mutually exchanging information. For example, the first information processing device 100 may transmit the indexes assigned to the plurality of individual small areas to an external information processing device. Then, the external information processing device may perform the encoding processing on the indexes, and may generate and transmit positional features as a result thereof to the first information processing device 100. This also enables the encoding unit 172 to obtain the positional features obtained by encoding the indexes assigned to the plurality of small areas.

### Addition Unit 173

For example, as described above, the addition unit 173 generates input data including a plurality of input features obtained by adding the positional feature of the relevant small area to each of the plurality of word features.

The input data includes, for example, input features relevant to the plurality of individual character strings. Each input feature is, for example, a feature in which the positional feature obtained by encoding the index of the small area relevant to the position of the relevant character string is added to the word feature extracted from the character string. Each input feature may be, for example, a vector (input feature vector) obtained by adding the position feature vector to the word feature vector of the relevant character string.

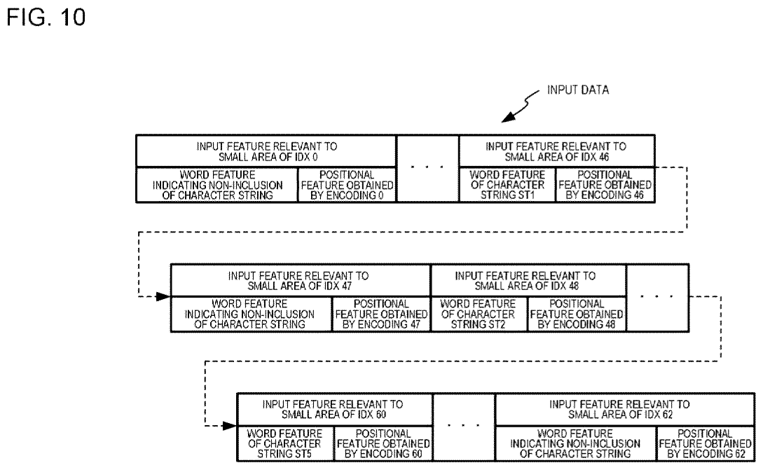

FIG. 10 is a diagram illustrating an exemplary configuration of the input data. An example is illustrated in which the input data includes a token in which input features (input feature vectors) relevant to the plurality of individual character strings are arranged in a line in ascending order of values indicated by the indexes of the small areas. An arrow of a dotted line in the drawing indicates an input feature that follows from an input feature. In the input data, it is sufficient if the relative positional relationship of the plurality of character strings is retained, and the input features may be arranged in predetermined order, such as descending order of the values indicated by the indexes, without being limited to the ascending order of the values indicated by the indexes of the small areas.

For example, it is assumed that the character strings ST1 to ST9 are indicated in the small areas of IDX 46, 48, 37, 50, 60, 11, 18, 22, and 24. In that case, the input feature relevant to the small area of IDX 46 includes the word feature (word feature vector) of the character string ST1 and the positional feature (position feature vector) obtained by encoding 46. The input features relevant to the small areas of IDX 48, 37, 50, 60, 11, 18, 22, and 24 each include the word feature (word feature vector) of the character strings ST1 to ST9 and the positional feature (position feature vector) obtained by encoding the value of IDX. In the drawing, a detailed configuration example is illustrated for the input features relevant to the small areas of IDX 0, 46, 47, 48, 60, and 62, and illustration of a detailed configuration example relevant to other small areas is omitted.

The word feature (word feature vector) of the small area not including a character string may be set to, for example, a predetermined value indicating non-inclusion of a character string, that is, a blank.

For example, when a plurality of character strings is included in one small area, the input data may include an input feature for each character string. In that case, a plurality of input features relevant to the plurality of character strings in one small area may include a positional feature (position feature vector) obtained by encoding IDX of the same small area. Those plurality of input features may be included in the input data in predetermined order in association with the positions of the character strings from which the word features (word feature vectors) included in the individual character strings are extracted. The predetermined order referred to here may be determined as appropriate. For example, the predetermined order may be order of proximity of the position of the character string to a predetermined point (e.g., upper left point, center, etc.) in the small area, a reference position in the target image, or the like.

With such input data being generated, data (token string) may be generated in which the word features (word feature vectors) related to the plurality of character strings included in the target image and their relative positional relationships are associated with each other and arranged in a line.

In general, a character string related to a target object is included near the position of the target object in many cases. Thus, with the input data retaining the relative positional relationship of the plurality of character strings, a larger number of character strings related to the target object may be accurately identified using the input data.

For example, with the target image being divided into a plurality of small areas with the position of the target object as a reference position, a token string that accurately indicates the relative positional relationship between the target object and each character string may be generated.

For example, with the small area having been divided to have a smaller area as it is closer to the target object, a token string that precisely indicates the relative positional relationship between the target object and each character string may be generated.

For example, with the small area having been divided to have a smaller area as it is closer to the target object with the position of the target object as a reference position according to a combination of the above, a token string that accurately and precisely indicates the relative positional relationship between the target object and each character string may be generated.

### (Output Data Acquisition Unit 180)

The output data acquisition unit 180 obtains, for example, output data obtained by inputting the input data to a language model as a token. The language model is, for example, a machine learning model obtained through training for performing language processing, and may be, for example, a large language model (LLM). The output data includes, for example, a feature (output feature) indicating a relative positional relationship between the target object and each of the plurality of character strings included in the target image. The output feature may be, for example, an output vector represented by a vector.

The language model may be provided in an information processing device (not illustrated) provided outside the first information processing device 100 and connected to each other via a communication network for mutually exchanging information. For example, the first information processing device 100 may transmit the input data to an external information processing device. Then, the external information processing device may input the input data to the language model, and may generate the output data as a result thereof to transmit it to the first information processing device 100. This also enables the output data acquisition unit 180 to obtain the output data obtained by inputting the input data to the language model as a token.

### (Relevant Information Acquisition Unit 190)

The relevant information acquisition unit 190 obtains a relevant character string of the target object obtained by inputting information for identifying the target object and the output data to a relevant character string extraction model.

The relevant character string extraction model is, for example, a machine learning model obtained through training for extracting, from a plurality of character strings included in an image, a relevant character string relevant to the target object included in the image. For example, when the information for identifying the target object and the output data are input, the relevant character string extraction model outputs object-related information including the relevant character string related to the target object.

The information for identifying the target object may be, for example, information that may identify the position of the target object in the target image. The position of the target object here may be represented by a coordinate position in the target image, or may be represented by an index of the small area. For example, the information for identifying the target object may include object information of the target object. The information for identifying the target object may include, for example, an index of the small area relevant to the position of the target object.

As a result, the object-related information may be generated based on the relative positional relationship between the target object and each of the plurality of small areas in the target image. The object-related information may include object information of the target object.

The relevant character string extraction model may be provided in an information processing device (not illustrated) provided outside the first information processing device 100 and connected to each other via a communication network for mutually exchanging information. For example, the first information processing device 100 may transmit the information for identifying the target object and the output data to an external information processing device. Then, the external information processing device may input the information for identifying the target object and the output data to the relevant character string extraction model, and may generate the object-related information as a result thereof to transmit it to the first information processing device 100. This also enables the relevant information acquisition unit 190 to obtain the relevant character string of the target object.

### (Output Control Unit 200 and Output Unit 210)

The output control unit 200 causes the output unit 210 to output various types of information. For example, the output control unit 200 causes the output unit 210 to output object-related information. A method of the output is typically display. In this case, the output unit 210 is, for example, a display, and the output control unit 200 causes the output unit 210 to display various types of information.

The output method is not limited to display, and may be, for example, transmission of information or the like. The output control unit 200 may cause the output unit 210 as a transmission unit to transmit various types of information, such as object-related information, to an external device. The device of the transmission destination may be determined in advance, or may be specified by the user, for example.

### (Exemplary Physical Configuration of Information Processing Device 100)

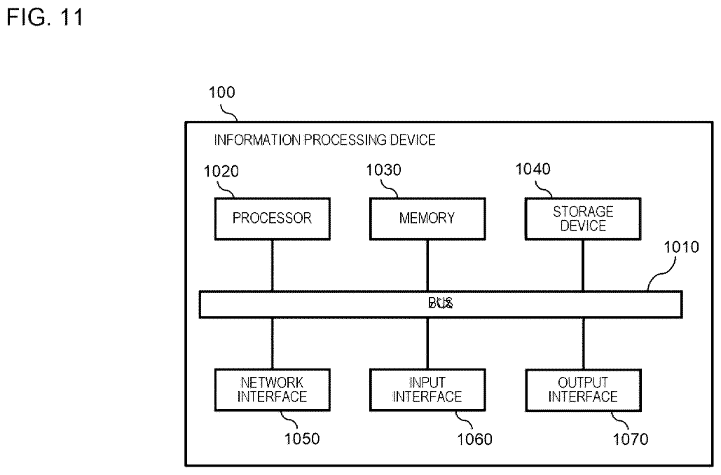

As illustrated in FIG. 11, for example, the information processing device 100 physically includes a bus 1010, a processor 1020, a memory 1030, a storage device 1040, a network interface 1050, an input interface 1060, and an output interface 1070.

The bus 1010 is a data transmission path through which the processor 1020, the memory 1030, the storage device 1040, the network interface 1050, the input interface 1060, and the output interface 1070 mutually exchange data. However, the method of connecting the processor 1020 and the like to each other is not limited to the bus connection.

The processor 1020 is a processor implemented by a central processing unit (CPU), a graphics processing unit (GPU), or the like.

The memory 1030 is a main storage device implemented by a random access memory (RAM) or the like.

The storage device 1040 is an auxiliary storage device implemented by a hard disk drive (HDD), a solid state drive (SSD), a memory card, a read only memory (ROM), or the like. The storage device 1040 stores program modules for implementing functions of an apparatus including the storage device. The processor 1020 reads those program modules into the memory 1030 to execute them, thereby implementing the functions associated with the program modules.

The network interface 1050 is an interface for connecting an apparatus including the network interface to a communication network.

The input interface 1060 is an interface for the user to input information. The input interface 1060 includes, for example, a touch panel, a keyboard, a mouse, and the like.

The output interface 1070 is an interface for presenting information to the user. The output interface 1070 includes, for example, a liquid crystal panel, an organic electro-luminescence (EL) panel, or the like.

As described above, the functions of the information processing device 100 may be implemented by software programs executed by the physical components in cooperation with each other. Thus, the present invention may be implemented as a software program, or may be implemented as a storage medium in which the program is recorded in a non-transitory manner. The information processing device may physically include a plurality of apparatuses (e.g., computers, etc.).

### (Operation and Effect)

As described above, according to the present example embodiment, the information processing device 100 includes the division unit 140, the recognition unit 150, the index assignment unit 160, the input data generation unit 170, and the output data acquisition unit 180.

The division unit 140 divides a target image including a target object and a plurality of character strings into a plurality of small areas. The recognition unit 150 performs character recognition processing using the target image, thereby recognizing the plurality of character strings and also recognizing positions of the plurality of character strings in the target image. The index assignment unit 160 assigns, to each of the plurality of small areas, an index associated with a relative positional relationship of the plurality of small areas in the target image. The input data generation unit 170 generates input data including an input feature in which a positional feature obtained by encoding the index of the small area relevant to the position of the character string is added to a word feature extracted from each of the plurality of character strings. The output data acquisition unit 180 obtains output data obtained by inputting the input data to a language model.

As a result, with respect to the target object and the plurality of character strings included in the periphery thereof in the target image, the output data processed by the language model in consideration of the relative positional relationship of the plurality of character strings may be obtained. With such output data being used, a character string relevant to the target object may be identified not only from a character string indicated by the target object but also from a wide range of character strings included in a region other than the target object in the target image. Thus, a larger number of character strings relevant to the target object may be accurately identified from the target image.

According to the present example embodiment, the input data generation unit 170 includes the word feature acquisition unit 171, the encoding unit 172, and the addition unit 173. The word feature acquisition unit 171 obtains the plurality of word features obtained by inputting the plurality of individual character strings to the word feature extraction model. The encoding unit 172 obtains the positional feature obtained by encoding the index assigned to each of the plurality of small areas. The addition unit 173 generates input data including the plurality of input features obtained by adding the positional feature of the relevant small area to each of the plurality of word features.

As a result, with respect to the target object and the plurality of character strings included in the periphery thereof in the target image, the input data in consideration of the relative positional relationship of the plurality of character strings may be generated and processed using the language model. With the output data as a result of the processing by the language model being used, a character string relevant to the target object may be identified not only from a character string indicated by the target object but also from a wide range of character strings included in a region other than the target object in the target image. Thus, a larger number of character strings relevant to the target object may be accurately identified from the target image.

According to the present example embodiment, the division unit 140 divides the target image into a plurality of small areas with the position of the target object in the target image as a reference position.

As a result, the possibility may be reduced in which the position of the target object is at the boundary of small areas or at a biased position in the vicinity of the boundary. Thus, the position of the target object in the target image may be correctly identified using the small areas.

According to the present example embodiment, the area of the plurality of small areas is smaller as it is closer to the reference position.

As a result, the position of the target object may be more precisely identified using the small areas. Thus, the position of the target object in the target image may be accurately identified using the small areas.

According to the present example embodiment, the information processing device 100 includes the relevant information acquisition unit 190. The relevant information acquisition unit 190 obtains the relevant character string of the target object obtained by inputting the information for identifying the target object and the output data to the relevant character string extraction model obtained through training for extracting a relevant character string related to an object included in an image from among a plurality of character strings included in the image.

As a result, a character string relevant to the target object may be obtained not only from the character string indicated by the target object but also from a wide range of character strings included in a region other than the target object in the target image. Thus, a larger number of character strings relevant to the target object may be accurately identified from the target image.

According to the present example embodiment, the information processing device 100 includes the object detection unit 120 and the target identifying means 130. The object detection unit 120 obtains object information including a position of the object detected from the target image. The target identifying means 130 identifies the target object, which is an object to be processed, from among the detected objects.

As a result, any object among the objects included in the target image may be identified as a target object. Thus, a larger number of character strings relevant to any target object may be accurately identified from the target image.

According to the present example embodiment, the target image includes at least one product, a product shelf on which the product is placed, and a product tag attached to the product shelf. The target object is a product identified from at least one product.

As a result, with the image obtained by capturing the product shelf on which the product is placed as a target image, a character string related to any product included in the image may be identified. Thus, a larger number of character strings related to the product may be accurately identified from the target image of the image obtained by capturing the product shelf on which the product is placed.

### Second Example Embodiment

While the exemplary case where the division to the matrix-shaped small areas is made has been described in the first example embodiment, a method of dividing a target image into a plurality of small areas is not limited to the method of the division into the matrix. The plurality of small areas may divide at least a part of the target image. In that case, the partial region of the target image divided into the plurality of small areas may include, for example, a target object.

The plurality of small areas may include a concentric circle or a spiral line centered on a reference position as a boundary. The plurality of small areas may be radially divided.

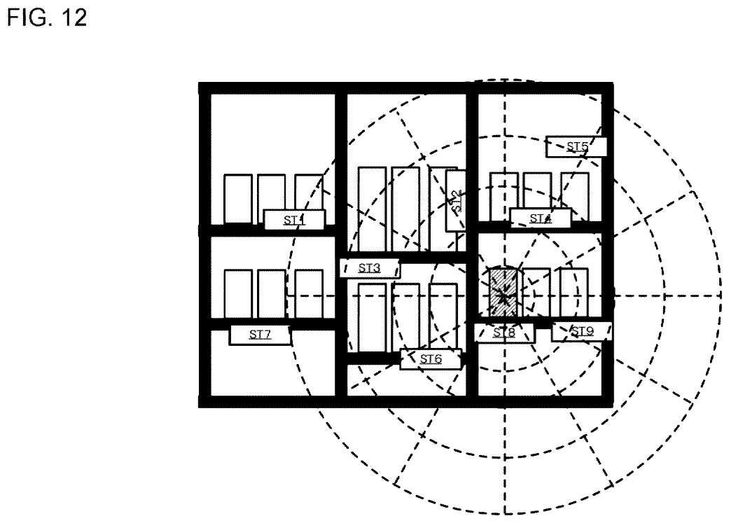

FIG. 12 illustrates an example in which the target image is divided into a plurality of divided areas having a concentric circular arc shape centered on the reference position. In the drawing, a boundary of the small areas is indicated by a dotted line. The index IDX of each small area may be, for example, a value obtained by a formula of IDX=M [log (r+1)/K/N]+[θ/M]. Coordinate values in a polar coordinate system centered on the position of the target image are represented by r and θ. N and M represent the number of divisions in the radial direction and in the circumferential direction, respectively.

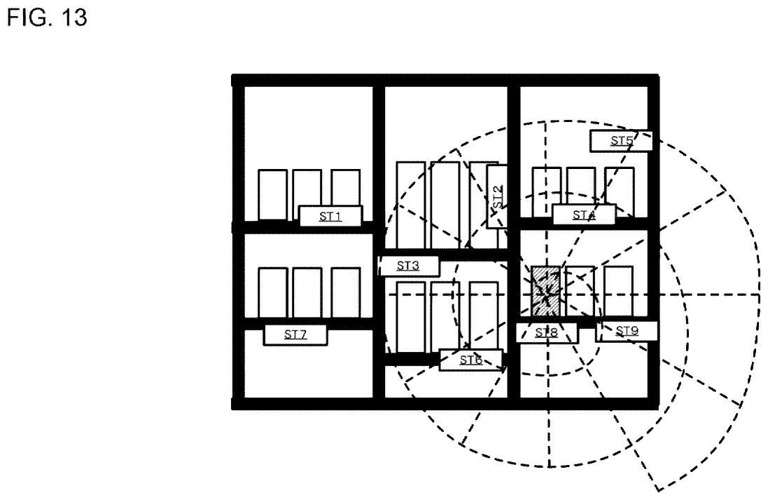

FIG. 13 illustrates an example in which the target image is divided into a plurality of divided areas having a concentric circular arc shape centered on the reference position. In the drawing, a boundary of the small areas is indicated by a dotted line. The index IDX of each small area may be, for example, a value obtained by a formula of IDX=Marginₙ|r−aθₙ|+[θ/M], θₙ={θ+2nπ}. Coordinate values in a polar coordinate system centered on the position of the target image are represented by r and θ. M represents the number of divisions in the circumferential direction. A value of n that minimizes the target formula is represented by Marginₙ. That is, Marginₙ|r−aθₙ| represents a value of n that minimizes the absolute value of r−aθₙ. A parameter (constant) for a logarithmic spiral is represented by a.

### (Operation and Effect)

As described above, according to the present example embodiment, the plurality of small areas includes a concentric circle or a spiral line centered on the reference position as a boundary.

As a result, with the radial division centered on the reference position being made, the target image may be easily divided into a plurality of small areas whose area is smaller as the small area is closer to the reference position. Thus, the position of the target object may be easily and precisely identified using the small areas. Accordingly, the position of the target object in the target image may be easily and accurately identified using the small areas.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

While a plurality of steps (processes) is described in order in the plurality of flowcharts used in the descriptions above, the execution order of the steps executed in each example embodiment is not limited to the described order. In each example embodiment, the order of the illustrated steps may be changed as long as no problem is raised in terms of content.

Some or all of the example embodiments described above may be described as the following Supplementary Notes, but are not limited to the following.

1

An information processing device including:
a division means for dividing a target image including a target object and a plurality of character strings into a plurality of small areas;
a recognition means for recognizing the plurality of character strings by performing character recognition processing using the target image and recognizing a position of the plurality of character strings in the target image;
an index assignment means for assigning an index associated with a relative positional relationship of the plurality of small areas in the target image to each of the plurality of small areas;
an input data generation means for generating input data including an input feature in which, to a word feature extracted from each of the plurality of character strings, a positional feature obtained by encoding the index of the small area relevant to the position of the character string is added; and
an output data acquisition means for obtaining output data obtained by inputting the input data to a language model.
   2

The information processing device according to 1, in which the input data generation means includes:
a word feature acquisition means for obtaining a plurality of the word features obtained by inputting the plurality of individual character strings to a word feature extraction model;
an encoding means for obtaining the positional feature obtained by encoding the index assigned to each of the plurality of small areas; and
an addition means for generating the input data including a plurality of the input features obtained by adding the positional feature of the relevant small area to each of the plurality of word features.
   3

The information processing device according to 1, or 2, in which
the division means divides the target image into the plurality of small areas with a position of the target object in the target image as a reference position.
   4.

The information processing device according to 3., in which
an area of each of the plurality of small areas is smaller as the small area is closer to the reference position.
   5

The information processing device according to 3., in which
the plurality of small areas includes a concentric circle or a spiral line centered on the reference position as a boundary.
   6.

The information processing device according to any one of 1. to 5., further including:
a relevant information acquisition means for obtaining a relevant character string of the target object obtained by inputting information for identifying the target object and the output data to a relevant character string extraction model obtained through training for extracting the relevant character string related to an object included in an image from a plurality of character strings included in the image.
   7.

The information processing device according to any one of 1. to 6., further including:
an object detection means for obtaining object information including a position of an object detected from the target image; and
a target identifying means for identifying the target object, which is an object to be processed, from among a plurality of the detected objects.
   8

The information processing device according to any one of 1. to 7., in which
the target image includes at least one product, a product shelf on which the product is placed, and a product tag attached to the product shelf, and
the target object includes a product identified from the at least one product.
   9

An information processing method for causing one or more computers to perform a process including:
dividing a target image including a target object and a plurality of character strings into a plurality of small areas;
recognizing the plurality of character strings by performing character recognition processing using the target image and recognizing a position of the plurality of character strings in the target image;
assigning an index associated with a relative positional relationship of the plurality of small areas in the target image to each of the plurality of small areas;
generating input data including an input feature in which, to a word feature extracted from each of the plurality of character strings, a positional feature obtained by encoding the index of the small area relevant to the position of the character string is added; and
obtaining output data obtained by inputting the input data to a language model.
   10.

The information processing method according to 9., in which the generating the input data includes:
obtaining a plurality of the word features obtained by inputting the plurality of individual character strings to a word feature extraction model;
obtaining the positional feature obtained by encoding the index assigned to each of the plurality of small areas; and
generating the input data including a plurality of the input features obtained by adding the positional feature of the relevant small area to each of the plurality of word features.
   11.

The information processing method according to 9, or 10., in which
the dividing the target image into the plurality of small areas divides the target image into the plurality of small areas with a position of the target object in the target image as a reference position.
   12.

The information processing method according to 11., in which
an area of each of the plurality of small areas is smaller as the small area is closer to the reference position.
   13.

The information processing method according to 11., in which
the plurality of small areas includes a concentric circle or a spiral line centered on the reference position as a boundary.
   14.

The information processing method according to any one of 9. to 13., further including:
obtaining a relevant character string of the target object obtained by inputting information for identifying the target object and the output data to a relevant character string extraction model obtained through training for extracting the relevant character string related to an object included in an image from a plurality of character strings included in the image.
   15.

The information processing method according to any one of 9. to 14., further including:
obtaining object information including a position of an object detected from the target image; and
identifying the target object, which is an object to be processed, from among a plurality of the detected objects.
   16.

The information processing method according to any one of 9. to 15., in which
the target image includes at least one product, a product shelf on which the product is placed, and a product tag attached to the product shelf, and
the target object includes a product identified from the at least one product.
   17.

A program for causing one or more computers to perform a process including:
dividing a target image including a target object and a plurality of character strings into a plurality of small areas;
recognizing the plurality of character strings by performing character recognition processing using the target image and recognizing a position of the plurality of character strings in the target image;
assigning an index associated with a relative positional relationship of the plurality of small areas in the target image to each of the plurality of small areas;
generating input data including an input feature in which, to a word feature extracted from each of the plurality of character strings, a positional feature obtained by encoding the index of the small area relevant to the position of the character string is added; and
obtaining output data obtained by inputting the input data to a language model.
   18.

The program according to 17., in which
the generating the input data includes:
obtaining a plurality of the word features obtained by inputting the plurality of individual character strings to a word feature extraction model;
obtaining the positional feature obtained by encoding the index assigned to each of the plurality of small areas; and
generating the input data including a plurality of the input features obtained by adding the positional feature of the relevant small area to each of the plurality of word features.
   19.

The program according to 17. or 18., in which
the dividing the target image into the plurality of small areas divides the target image into the plurality of small areas with a position of the target object in the target image as a reference position.
   20.

The program according to 19., in which
an area of each of the plurality of small areas is smaller as the small area is closer to the reference position.
   21.

The program according to 19., in which
the plurality of small areas includes a concentric circle or a spiral line centered on the reference position as a boundary.
   22.

The program according to any one of 17. to 21., the program causing the one or more computers to perform the process further including:
obtaining a relevant character string of the target object obtained by inputting information for identifying the target object and the output data to a relevant character string extraction model obtained through training for extracting the relevant character string related to an object included in an image from a plurality of character strings included in the image.
   23.

The program according to any one of 17. to 22., the program causing the one or more computers to perform the process further including:
obtaining object information including a position of an object detected from the target image; and
identifying the target object, which is an object to be processed, from among a plurality of the detected objects.
   24.

The program according to any one of 17. to 23., in which
the target image includes at least one product, a product shelf on which the product is placed, and a product tag attached to the product shelf, and
the target object includes a product identified from the at least one product.
   25.

A recording medium on which the program according to any one of 17. to 24. is recorded.

1. An information processing apparatus comprising:
a memory configured to store instructions; and
a processor configured to execute the instructions to:
divide a target image including a target object and a plurality of character strings into a plurality of small areas;
recognize the plurality of character strings by performing character recognition processing using the target image and recognizing a position of the plurality of character strings in the target image;
assign an index associated with a relative positional relationship of the plurality of small areas in the target image to each of the plurality of small areas;
generate input data including an input feature in which, to a word feature extracted from each of the plurality of character strings, a positional feature obtained by encoding the index of the small area relevant to the position of the character string is added; and
obtain output data obtained by inputting the input data to a language model.

2. The information processing apparatus according to claim 1, wherein
generating the input data includes:
obtaining a plurality of the word features obtained by inputting the plurality of individual character strings to a word feature extraction model;
obtaining the positional feature obtained by encoding the index assigned to each of the plurality of small areas; and
generating the input data including a plurality of the input features obtained by adding the positional feature of the relevant small area to each of the plurality of word features.

3. The information processing apparatus according to claim 1, wherein
each of the plurality of small areas is related to a position of the target object in the target image as a reference position.

4. The information processing apparatus according to claim 3, wherein
an area of each of the plurality of small areas is smaller as the small area is closer to the reference position.

5. The information processing apparatus according to claim 3, wherein
the plurality of small areas includes a concentric circle or a spiral line centered on the reference position as a boundary.

6. The information processing apparatus according to claim 1, wherein the processor configured to further execute the instructions to:
obtain a relevant character string of the target object obtained by inputting information for identifying the target object and the output data to a relevant character string extraction model obtained through training for extracting the relevant character string related to an object included in an image from a plurality of character strings included in the image.

7. The information processing apparatus according to claim 1, wherein the processor configured to further execute the instructions to:
obtain object information including a position of an object detected from the target image; and
identify the target object, which is an object to be processed, from among a plurality of the detected objects.

8. The information processing apparatus according to claim 1, wherein
the target image includes at least one product, a product shelf on which the product is placed, and a product tag attached to the product shelf, and
the target object includes a product identified from the at least one product.

9. An information processing method for causing one or more computers to perform a process comprising:
dividing a target image including a target object and a plurality of character strings into a plurality of small areas;
recognizing the plurality of character strings by performing character recognition processing using the target image and recognizing a position of the plurality of character strings in the target image;
assigning an index associated with a relative positional relationship of the plurality of small areas in the target image to each of the plurality of small areas;
generating input data including an input feature in which, to a word feature extracted from each of the plurality of character strings, a positional feature obtained by encoding the index of the small area relevant to the position of the character string is added; and
obtaining output data obtained by inputting the input data to a language model.

10. A non-transitory computer readable medium comprising a program recorded thereon, the program for causing one or more computers to perform a process comprising:
dividing a target image including a target object and a plurality of character strings into a plurality of small areas;
recognizing the plurality of character strings by performing character recognition processing using the target image and recognizing a position of the plurality of character strings in the target image;
assigning an index associated with a relative positional relationship of the plurality of small areas in the target image to each of the plurality of small areas;
generating input data including an input feature in which, to a word feature extracted from each of the plurality of character strings, a positional feature obtained by encoding the index of the small area relevant to the position of the character string is added; and
obtaining output data obtained by inputting the input data to a language model.
